(19) United States
(12) Patent Application Publication
(10) Pub. No.: US 2005/0007460 A1
(43) Pub. Date: Jan. 13, 2005

(54) Systems and methods for counteracting lens vignetting

(76) Inventors: Donald J. Stavely, Windsor, CO (US); Christopher A. Whitman, Fort Collins, CO (US); Robert E. Sobol, Fort Collins, CO (US); Kevin J. Matherson, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/614,936

(22) Filed: Jul. 8, 2003

(51) Int. Cl. H04N 3/14; H04N 5/335

(52) U.S. Cl. 348/222.1; 348/296; 348/308

(57) ABSTRACT

Disclosed are systems and methods for counteracting lens vignetting. In one embodiment, a system and method pertain to resetting pixels of an image sensor, and reading pixels of the image sensor after they have been reset such that the time between resetting and reading is greater for pixels adjacent edges of the sensor than for pixels adjacent a center of the sensor.

### BACKGROUND

Lens vignetting is a phenomenon in which the amount of light within an image decreases in a radial direction from the center of the image. Specifically, due to the characteristics of typical lens systems, light decreases according to the cosine to the fourth power of the distance from the center of the image. This light decrease results in a perceived darkening of the edges of the image that, in some cases, is very noticeable and, if unintentional, is unacceptable. FIG. 1 schematically illustrates darkening of the edges and comers of an image 100 with a shaded area 102.

Vignetting can be overcome, or at least counteracted, in a variety of different ways. In one method, the lens system of the image capture device is carefully designed such that vignetting is minimized. This solution is unattractive, however, because correcting such vignetting may require the use of more expensive and/or larger components (e.g., lenses), thereby increasing the cost of the image capture device and/or its size. Furthermore, correction of vignetting through lens system design may be difficult to achieve in that the lens designer would need to overcome such vignetting while simultaneously correcting lens aberrations that are inherent in any given lens system.

In another method particular to digital imaging, lens vignetting is electronically compensated for by increasing the brightness of the image around its edges. For example, a light gain factor that increases as a function of distance from the center of the lens (and therefore image) is applied to the captured image data. However, such “gaining up” of the edges of an image to increase brightness simultaneously increases noise that reduces image quality.

Lens vignetting can, at least in theory, be controlled by adjusting the amount of exposure that is provided to the periphery of the image. Unfortunately, there is currently no way to control exposure in this manner. Generally speaking, exposure (or “shuttering”) in image capture devices is controlled using either a mechanical shutter that alternately blocks and passes light, or a solid-state image sensor that is reset and then read after the passage of an exposure time period. In both cases, exposure time is relatively constant over the entire image.

In the case of shuttering using a complimentary metal oxide semiconductor (CMOS) image sensor, entire rows of pixels are sequentially reset and then sequentially read. Such resetting and reading is depicted in FIG. 2. As indicated in this figure, the various rows of the image sensor 200 (and the pixels they contain) may be both reset and read on a row-by-row basis. In such a case, rows of pixels are reset and are exposed (in area 202) to light signals until such time when the pixels in the rows are read (in area 204). Such resetting and reading occurs at a constant rate such that each pixel is exposed the same amount of time. As a result, a rolling shutter effect is achieved.

This effect is analogous to the operation of a focal plane shutter in single-lens reflex (SLR) film camera. A first curtain is opened from the top of the film plane down to initiate the exposure. Some time later, a second curtain closes from the top to the bottom of the film plane. For short exposures, the closing curtain begins its travel before the opening curtain finishes. The result is that an open slit whose width is proportional to the desired exposure time traverses from top to bottom.

### SUMMARY

Disclosed are systems and methods for counteracting lens vignetting. In one embodiment, a system and method pertain to resetting pixels of an image sensor, and reading pixels of the image sensor after they have been reset such that the time between resetting and reading is greater for pixels adjacent edges of the sensor than for pixels adjacent a center of the sensor.

### BRIEF DESCRIPTION OF THE DRAWINGS

The disclosed systems and methods can be better understood with reference to the following drawings. The components in the drawings are not necessarily to scale.

FIG. 1 is a schematic view of an image that includes darkened edges resulting from lens vignetting.

FIG. 2 is a schematic view that illustrates a prior art method of shuttering an image sensor.

FIG. 3 is a block diagram of an embodiment of an image capture device that counteracts lens vignetting.

FIG. 4 is a schematic of a circuit associated with a pixel of an image sensor shown in FIG. 3.

FIG. 5 is a flow diagram illustrating an embodiment of a method for counteracting lens vignetting.

FIGS. 6A-6C are schematic views illustrating a first embodiment of a method for shuttering an image sensor.

FIGS. 7A-7C are schematic views illustrating a second embodiment of a method for shuttering an image sensor.

FIG. 8 is a plot that compares light response as a function of radial distance from the center of a prior art sensor and sensor that is read such that lens vignetting is counteracted.

FIG. 9 is a schematic view illustrating a third embodiment of a method for shuttering an image sensor.

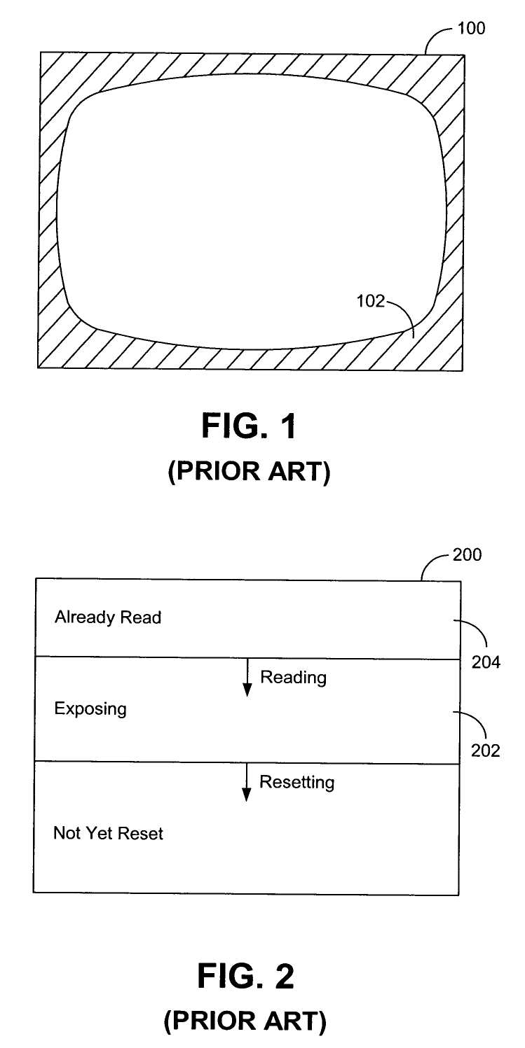

### DETAILED DESCRIPTION

As identified in the foregoing, lens vignetting can result in unacceptable darkening around the edges of an image. Although techniques exist for correcting or compensating for such vignetting, each has attendant drawbacks. As is disclosed herein, however, lens vignetting can be effectively counteracted by controlling an image sensor of the image capture device in a manner in which the portions of the sensor adjacent the sensor edges are exposed to a greater extent than a central portion of the sensor. In such a case, more light is collected by the image sensor around its edges, thereby brightening the edges of the image without requiring specialized design of the lens system or post-processing techniques that increase image noise.

Disclosed herein are embodiments of systems and methods for counteracting lens vignetting. Although particular embodiments are disclosed, these embodiments are provided for purposes of example only to facilitate description of the disclosed systems and methods. Accordingly, other embodiments are possible.

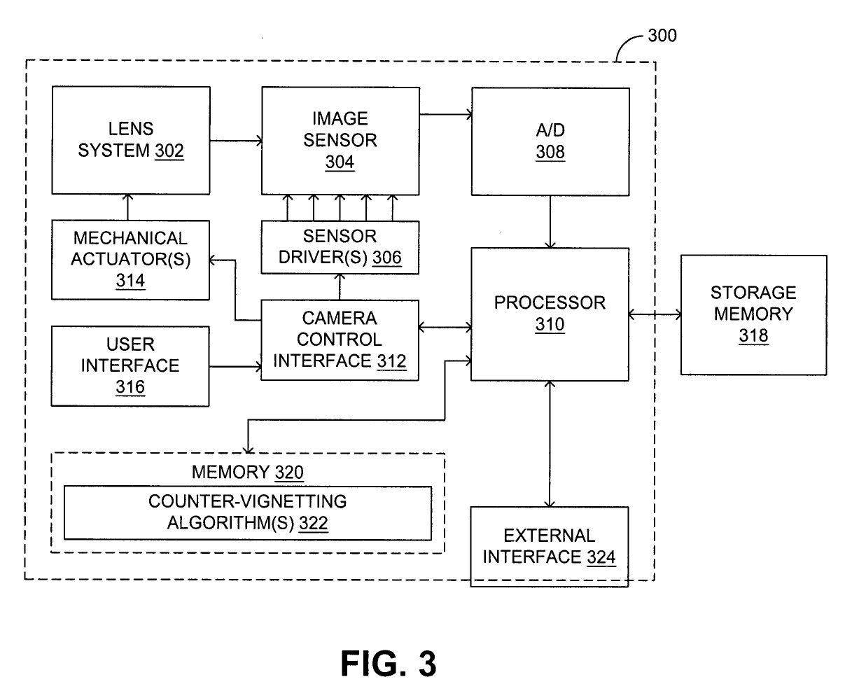

Referring now to the drawings, in which like numerals indicate corresponding parts throughout the several views, FIG. 3 illustrates an embodiment of an image capture device 300 that is implemented to counteract lens vignetting. In the example of FIG. 3, the device 300 is configured as a digital camera. Although a digital camera is illustrated in FIG. 3 and is explicitly discussed herein, the device 300 more generally comprises any device that digitally captures images. For the purposes of discussion of FIG. 3, however, the image capture device 300 is referred to from this point forward as a “camera.”

As indicated FIG. 3, the camera 300 includes a lens system 302 that conveys images of viewed scenes to an image sensor 304. The lens system 302 comprises one or more lenses, as well as other components that control or modify the collection of light for the purposes of capturing images. Such components include, for example, an aperture mechanism. The image sensor 304 comprises a plurality of sensor elements or pixels that collect light that is transmitted to the sensor by the lens system 302. The sensor 304 is configured as a randomly-addressable image sensor such that any of the sensor pixels may be addressed (e.g., read) at any given time via associated row and column conductors. By way of example, the image sensor 304 comprises a complimentary metal oxide semiconductor (CMOS) sensor. In any case, the image sensor 304 is driven by a sensor driver 306. The analog image signals captured by the sensor 304 are provided to an analog-to-digital (A/D) converter 308 for conversion into binary code that can be processed by a processor 310.

Operation of the sensor driver 306 is controlled through a camera control interface 312 that is in bi-directional communication with the processor 310. Also controlled through the interface 312 are one or more mechanical actuators 314 that are used to control operation of the lens system 302. These actuators 314 include, for instance, motors used to control the aperture mechanism, focus, and zoom. Operation of the camera control interface 312 may be adjusted through manipulation of a user interface 316 that comprises the various components used to enter selections and commands into the camera 300, such as a shutter-release button and various control buttons provided on the camera.

Captured digital images may be stored in storage memory 318, such as that contained within a removable solid-state memory card (e.g., Flash memory card). In addition to this memory, the camera comprises permanent (i.e., non-volatile) memory 320. In the embodiment of FIG. 3, the memory 320 includes one or more counter-vignetting algorithms 322 that control the manner in which the image sensor 304 is exposed (“shuttered”) such that lens vignetting is counteracted. Notably, the functionality of the algorithms 322 may be incorporated into the hardware of the processor 310 and/or the control interface 312, if desired.

In addition to the aforementioned components, the camera 300 comprises an external interface 324 through which data (e.g., images) may be transmitted to another device, such as a personal computer (PC). By way of example, this interface 324 comprises a universal serial bus (USB) connector.

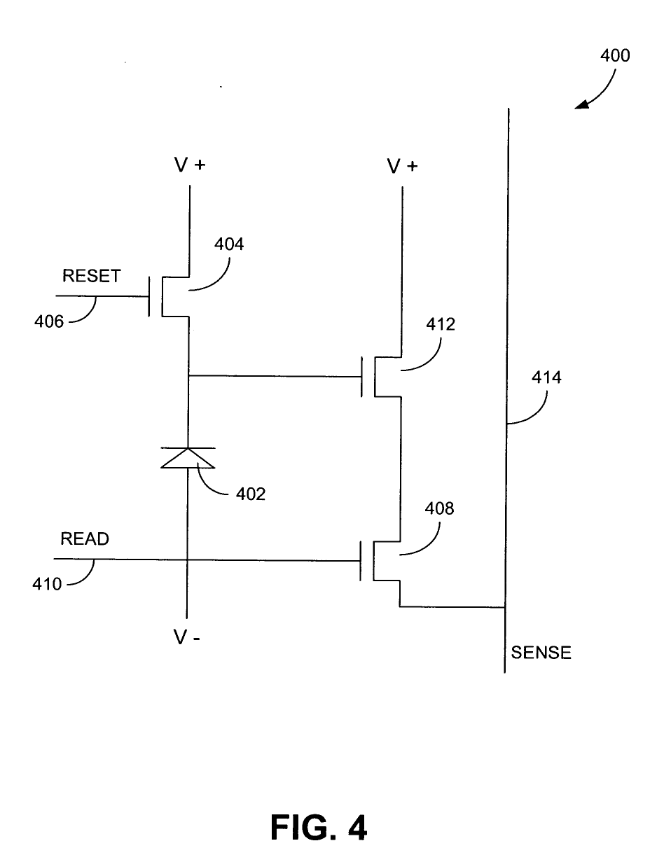

FIG. 4 illustrates an embodiment of a reset/read circuit 400 that is associated with each of one or more of the pixels of the image sensor 304 identified in FIG. 3. As indicated in FIG. 4, the circuit comprises 400 a photodiode 402 that is used to “collect” light (in the form of a electrical charge) transmitted to the sensor 304 via the lens system 302. The operation of the photodiode 402 is controlled through a plurality of transistors including a reset transistor 404 that is connected to a reset line 406, a read transistor 408 that is connected to a read line 410, and an intermediate transistor 412 that links the photodiode and the read transistor.

The reset transistor 404 is controlled to reset its associated photodiode 402 when an appropriate control voltage is transmitted along the reset line 406 to a gate of the transistor. Assuming there is ambient light, the photodiode 402 begins collecting light (charge) once it has been reset and continues to do so for a predetermined period of time associated with the amount of exposure that is desired for the particular image that is being captured. During this time, the intermediate transistor 412 acts as a source follower that converts the charge collected by the photodiode 402 into a voltage signal, which is applied to the read transistor 408. At the expiration of the predetermined time, the read transistor 408 is activated using an appropriate control voltage sent to the gate of the transistor via the read line 410. At this point, the voltage signal is transmitted along a sense line (e.g., column) 414 so that the amount and nature of the light sensed by the pixel can be determined.

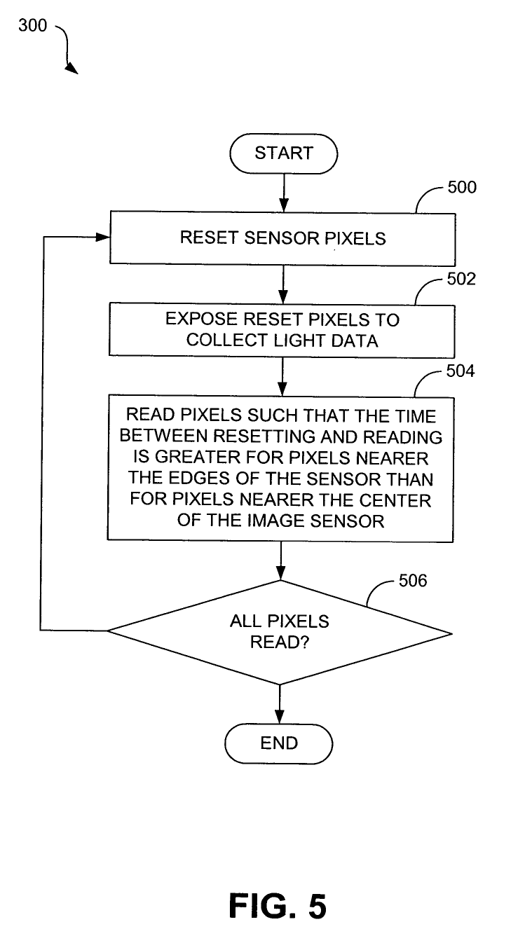

FIG. 5 is a flow chart of a method for counter-acting lens vignetting. It is noted that any process steps or blocks described in the flow diagrams of this disclosure may represent modules, segments, or portions of program code that includes one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

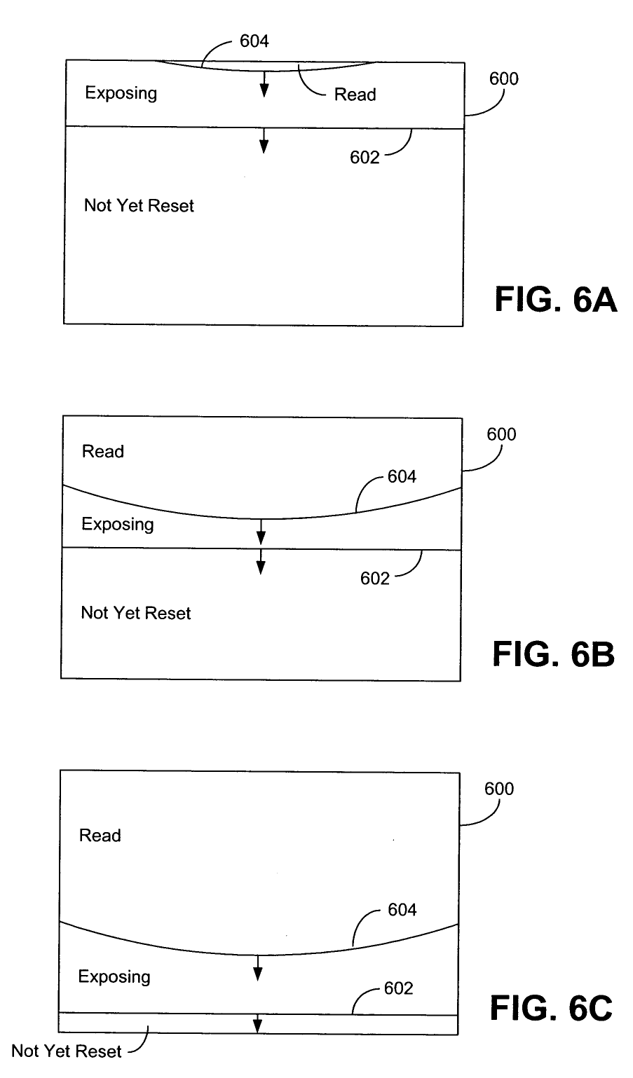

Beginning with block 500, the sensor pixels are reset such that, as indicated in block 502, pixels are exposed to collect light data. Resetting can, for example, occur in the manner described above in relation to FIG. 4 on a line-by-line basis such that entire lines (e.g., rows) are reset at substantially the same time. FIG. 6A-6C illustrate a first embodiment of sensor shuttering, and therefore an example of such line-by-line resetting. In this example, an image sensor 600 is reset and read from the one edge of the sensor to the opposite edge of the sensor and, in particular, from the top edge to the bottom edge. A reset line 602 is shown in these figures that represents the progression of resetting of sensor pixels in a line-by-line (row-by-row) manner. As is apparent from FIGS. 6A-6C when viewed in sequence, the reset line 602 traverses the image sensor 600 so that an area of the sensor that has not yet been reset is reset line-by-line so as to expose a portion of the sensor.

Returning to FIG. 5, pixels reading begins after the expiration of a predetermined time period. As indicated in block 504, this reading is performed such that the time between resetting and reading, i.e., the exposure time, is greater for pixels nearer the edges of the sensor than for pixels nearer the center of the image.

An embodiment of such reading is also illustrated in FIGS. 6A-6B. With reference first to FIG. 6A, pixels are read starting from the point at which the resetting began, in this case the top edge of the image sensor 600. The progression of this reading is represented by a read line 604, on one side of which pixels are still being exposed and on the other side of which pixels have already been read.

Unlike the pixel resetting, which occurred on an entire line-by-line basis, selected pixels of selected lines (rows) are read, for instance in the manner described above in relation to FIG. 4. More particularly, pixels adjacent the center of a first line are read, followed by a greater number of pixels adjacent the center of the following line, and so forth such that, as first indicated in FIG. 6B, entire lines of pixels approximating curving rows are ultimately read substantially simultaneously. Such selective reading is possible due to the randomly-addressable nature of the image sensor 600. Reading in this manner results in the read line 604 having a curved configuration in which center of the read line is the leading edge of the line. This curved configuration reflects a delay in the reading of pixels spaced from the center of the sensor 600 and, therefore, a greater duration of exposure for those pixels. This increased exposure is apparent from the greater separation between the reset line 602 and the read line 604 adjacent the lateral edges of the sensor 600 as compared to separation at the center of the sensor.

Because exposure increases as a function of lateral distance from the center of the image sensor 600, more light is collected by pixels as their distance from the center of the sensor increases. This phenomenon increases the brightness of the image captured by the sensor 600 and, in turn, counteracts the effects of lens vignetting in images captured using the sensor.

Notably, the exposure differential obtained through implementation of the resetting/reading process described above counteracts the effects of lens vignetting only in one direction, namely the lateral direction in the example shown in the figures. Accordingly, resetting and reading pixels in that manner, by itself, will not counteract vignetting that causes darkening of the other (i.e., top and bottom) edges of images captured using the sensor 600. However, the effects of such vignetting can be simultaneously counteracted by varying the relative speed at which pixels are reset and read. Such varying is also depicted in FIGS. 6A-6C.

With reference back to FIG. 6A, at the beginning of the resetting/reading process, the separation between the reset line 602 and the read line 604 is relatively large. However, when resetting and reading progresses to the point at which pixels adjacent the center of the sensor (in a vertical direction in the example shown in the figures) are being exposed, this separation is decreased, as indicated in FIG. 6B. Finally, when the resetting/reading process progresses to the point at which pixels adjacent the opposite edge (bottom edge in the example shown in the figures) of the sensor 600 are being exposed, as in FIG. 6C, the separation between the reset and read lines 602 and 604 is again relatively large.

Such varying separation reflects the varying relative speed of progression between the read line 602 and the read line 604. The varying relative speed can be achieved, for example, by maintaining a constant reset rate (as a function of distance traveled across the sensor 600) and adjusting the speed at which reading occurs such that the pixel reading rate increases toward the center of the sensor and again decreases as reading progresses outward toward the opposite edge of the sensor in the direction in which the sensor is traversed. The net effect of the varying relative speed, no matter how achieved, and the varying separation it provides, is that pixel exposure increases as a function of distance away from the center of the image sensor 600. Therefore, exposure times are increased for the pixels as a function of their distance from the center of the sensor 600 in both the horizontal and vertical directions.

Returning to FIG. 5, flow next continues to decision block 506 at which it is determined whether all of the sensor pixels have been read. If not, flow returns to block 500 and the resetting/reading process described above continues.

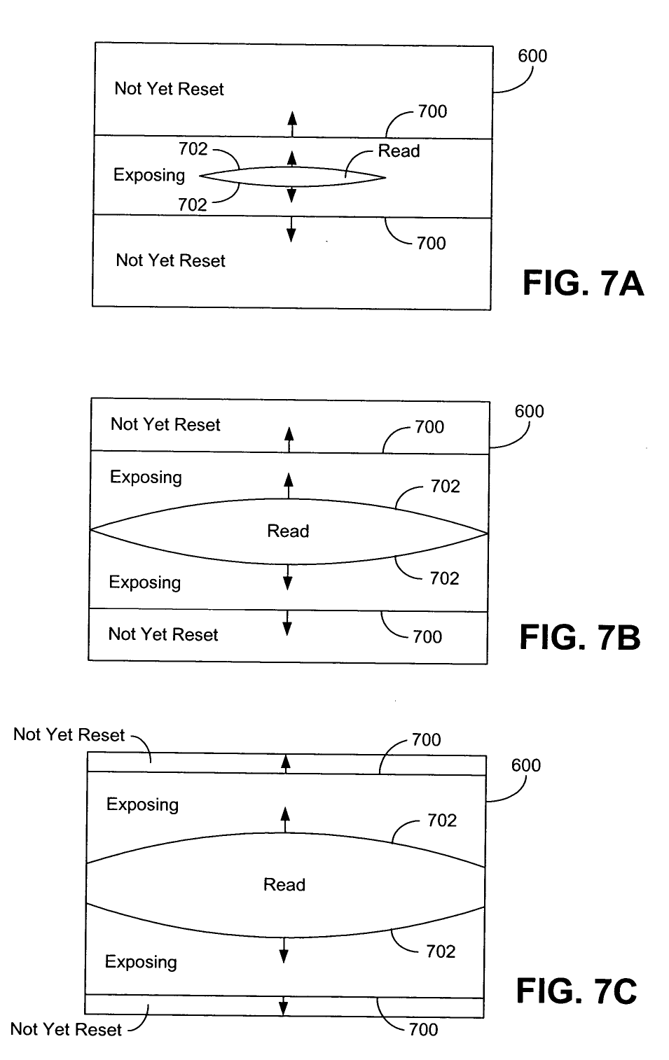

In the shuttering process described in relation to FIGS. 6A-6C, pixel resetting and reading occurred from one edge of the sensor to the opposite edge (top to bottom in the example shown in the figures). Similar results can be achieved using other resetting/reading processes, however, as long as resetting and reading are controlled in a manner such that exposure times for the pixels adjacent the edges of the sensor are greater than those for pixels adjacent the center of the sensor. FIGS. 7A-7C illustrate a second embodiment of a method for shuttering the sensor 600 that achieves this goal. In this embodiment, pixel resetting again occurs in a line-by-line manner. However, this resetting begins in the center of the sensor 600 and progresses simultaneously outward toward two opposite edges (top and bottom edges in the example shown in FIGS. 7A-7C). Accordingly, two reset lines 700 representing the progression of resetting of sensor pixels in a line-by-line (row-by-row) manner are depicted.

In the embodiment shown in FIGS. 7A-7C, the reset lines 700 traverse the image sensor 600 so that areas of the sensor that have not yet been reset are reset line-by-line. In this case, reading begins from the center of the sensor 600 so that reading progresses, as represented by read lines 702, in the same directions in which the resetting occurred. As in the embodiment of FIGS. 6A-6C, reading occurs such that pixels adjacent the center of a first line (row) are read, followed by a greater number of pixels adjacent the center of the following line (row), and so forth such that, as first indicated in FIG. 7B, entire lines (rows) are ultimately read substantially simultaneously.

As in the previous embodiment, reading in this manner results in the read lines 702 having a curved configuration in which the center of the line comprises the leading edge of the line. This curved configuration reflects a delay in the reading of pixels spaced from the center of the sensor 600 and, therefore, a greater duration of exposure for those pixels. This increased exposure is evident from the greater separation between the reset lines 700 and their associated (trailing) read lines 702 adjacent the lateral edges of the sensor 600 as compared to separation at the center of the sensor. Again, this phenomenon increases the brightness of the edges of the image captured by the sensor 600 and, in turn, counteracts the effects of lens vignetting.

Furthermore, as in the embodiment of FIGS. 6A-6C, the effects of vignetting in the direction of resetting/reading progression (the vertical direction in the example shown in FIGS. 7A-7C) can simultaneously be counteracted by varying the relative speed at which pixels are reset and read. Such varying relative speed is also depicted in FIGS. 7A-7C. Specifically, the separation between the reset lines 700 and their associated read lines 702 (and therefore exposure duration) is greater adjacent the edges (top and bottom in the example shown in FIGS. 7A-7C) than adjacent the center of the sensor.

In the embodiments shown in FIGS. 6A-6C and 7A-7C, shuttering (resetting and reading) occur in a vertical direction, whether it be from one edge of the sensor to the other, or from the center of the sensor out toward its edges. It is noted, however, that such shuttering can, alternatively, occur in a horizontal direction such that pixels of various columns (as opposed to rows) of the sensor may be sequentially reset and read.

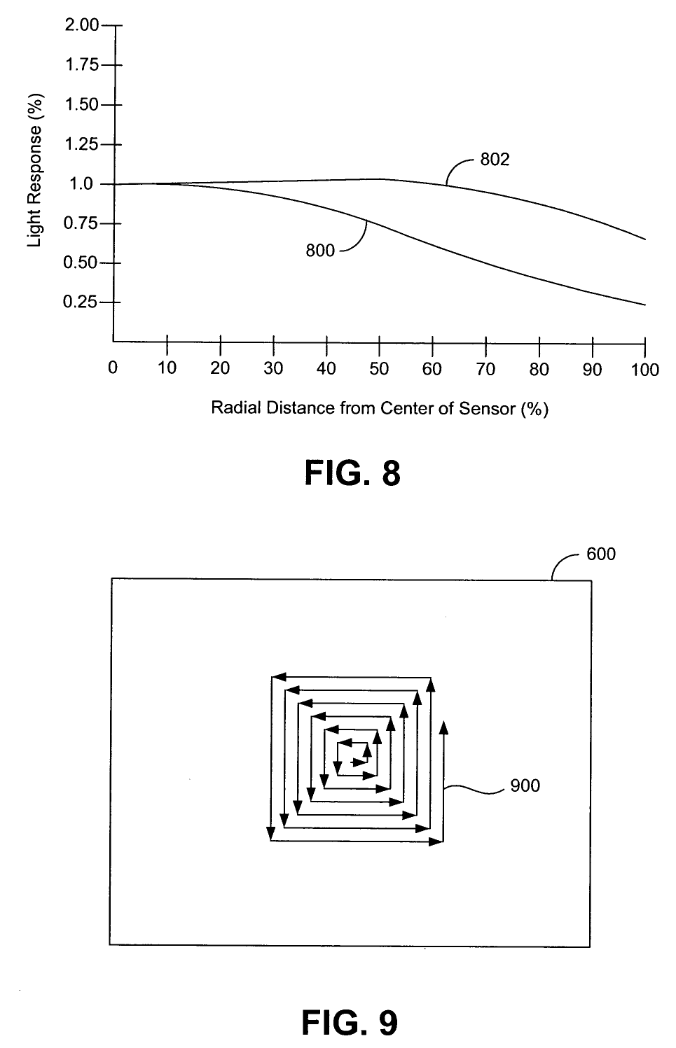

FIG. 8 illustrates the effect of compensating for lens vignetting using any of the methods described above. In particular, this figure plots light response (with 1.0 indicating unity or 100% light collection) as a function of radial distance out from the center of an image sensor (in terms of percentage of the distance to an edge of the sensor). Line 800 indicates the light response without vignetting compensation. As is evident from this line, the light response is reduced as the distance from the center of the sensor increases. In fact, the light response at the edge of the sensor is approximately 25% of that at the center of the sensor. Line 802 indicates the light response that can be achieved when vignetting compensation of the type described above is used. As is apparent from this line, substantially less reduction in light response (and therefore brightness) occurs at the edge of the sensor.

FIG. 9 illustrates a third embodiment of a method for shuttering the sensor 600. In this embodiment, pixel resetting occurs substantially simultaneously across the entire sensor 600 such that all of the sensor pixels begin exposing substantially simultaneously. Once such resetting occurs, reading begins from the center of the sensor 600 outward in a spiral manner at a constant rate so that pixels adjacent the center of the sensor are read first and the pixels adjacent the edges of the sensor are read last. Such reading is represented by the continuous read line 900. Reading in this manner results in a delay in the reading of pixels spaced from the center of the sensor 600 and, therefore, a greater duration of exposure for those pixels. Again, this phenomenon increases the brightness of the edges of the image captured by the sensor 600 and, in turn, counteracts the effects of lens vignetting.

1. A method for counteracting lens vignetting, comprising:
resetting pixels of an image sensor; and
reading pixels of the image sensor after they have been reset such that the time between resetting and reading is greater for pixels adjacent edges of the sensor than for pixels adjacent a center of the sensor.

2. The method of claim 1, wherein resetting pixels comprises resetting pixels on a line-by-line basis across the image sensor.

3. The method of claim 2, wherein resetting pixels further comprises resetting pixels beginning from one edge of the sensor and ending at an opposite edge of the sensor.

4. The method of claim 2, wherein resetting pixels further comprises resetting pixels beginning from the center of the sensor and ending at opposite edges of the sensor.

5. The method of claim 1, wherein resetting pixels comprises resetting all sensor pixels at substantially the same time.

6. The method of claim 1, wherein reading pixels comprises reading pixels beginning from one edge of the sensor and ending at an opposite edge of the sensor.

7. The method of claim 1, wherein reading pixels comprises reading pixels beginning from the center of the sensor and ending at opposite edges of the sensor.

8. The method of claim 1, wherein reading pixels comprises reading pixels such that pixel exposure time increases as a function of distance from the center of the sensor.

9. The method of claim 1, wherein reading pixels comprises reading pixels such that reading of pixels spaced from the center of the sensor is delayed relative to reading of pixels adjacent the center of the sensor so that exposure time for the pixels spaced from the center of the sensor is greater than for pixels adjacent the center of the sensor.

10. The method of claim 1, wherein reading pixels comprises reading selected pixels of selected lines so as to form a curved read line representative of progression of pixel reading across the sensor.

11. The method of claim 1, wherein reading pixels comprises reading pixels such that pixels are reset and read with a varying relative speed of progression.

12. The method of claim 11, wherein reading pixels further comprises resetting pixels at a constant reset rate and adjusting the speed at which pixels are read such that a pixel reading rate is higher adjacent the center of the sensor as compared to adjacent edges of the sensor.

13. The method of claim 1, wherein pixels are reset and read such that exposure times are increased for the sensor pixels as a function of their distance from the center of the sensor in both a horizontal and a vertical direction.

14. The method of claim 1, wherein reading pixels comprises reading pixels beginning at the center of the image sensor and spiraling outward so that pixels adjacent the center of the sensor are read first and pixels adjacent edges of the sensor are read last.

15. A method for counteracting lens vignetting, comprising:
resetting pixels of an image sensor in a line-by-line manner; and
reading pixels of the image sensor after they have been reset, wherein the pixels are read such that:
(a) relative to a direction of progression across the image sensor, reading of pixels spaced from a center of the image sensor is delayed relative to reading of pixels adjacent the center of the sensor such that exposure time for pixels spaced from the center of the sensor is greater than for pixels adjacent the center of the sensor, and
(b) pixels are reset and read with a varying relative speed of progression such that a pixel reading rate is higher adjacent the center of the sensor as compared to adjacent edges of the sensor.

16. The method of claim 15, wherein resetting pixels further comprises resetting pixels beginning from one edge of the sensor and ending at an opposite edge of the sensor.

17. The method of claim 15, wherein resetting pixels further comprises resetting pixels beginning from the center of the sensor and ending at opposite edges of the sensor.

18. The method of claim 15, wherein reading pixels comprises reading pixels such that pixel exposure time increases as a function of distance from the center of the sensor.

19. The method of claim 15, wherein pixels are reset and read such that exposure times are increased for the sensor pixels as a function of their distance from the center of the sensor in both a horizontal and a vertical direction.

20. A system for counteracting lens vignetting, comprising:
a solid-state image sensor including a plurality of randomly-accessible pixels; and
logic configured to read sensor pixels after they have been reset such that the time between resetting and reading is greater for pixels adjacent edges of the sensor than for pixels adjacent a center of the sensor.

21. The system of claim 20, wherein the image sensor comprises a complimentary metal oxide semiconductor (CMOS) sensor.

22. The system of claim 20, wherein the logic is configured to read pixels in a manner in which pixel exposure time increases as a function of distance from the center of the sensor.

23. The system of claim 20, wherein the logic is configured to read pixels in a manner in which reading of pixels spaced from a center of the sensor is delayed relative to reading of pixels adjacent the center of the sensor such that exposure time for pixels spaced from the center of the sensor is greater than for pixels adjacent the center of the sensor.

24. The system of claim 20, wherein the logic is configured to read pixels in a manner in which pixels are reset and read with a varying relative speed of progression.

25. A system for counteracting lens vignetting, comprising:
means for collecting light; and
means for reading the means for collecting light, the means for reading being configured to read such that an exposure time for portions of the means for collecting light adjacent its center is less than an exposure time for portions of the means for collecting light data adjacent its edges.

26. The system of claim 25, wherein the means for collecting light data comprise a complimentary metal oxide semiconductor (CMOS) sensor that includes a plurality of randomly-addressable pixels.

27. The system of claim 25, wherein the means for reading are configured to read the randomly-addressable pixels in a manner such that pixel exposure times increase as a function of distance from the center of the sensor in both a horizontal and a vertical direction.

28. A digital camera, comprising:
a lens system;
a solid-state image sensor that receives light transmitted by the lens system, the image sensor including a plurality of randomly-accessible pixels; and
a counter-vignetting algorithm that is configured to reset sensor pixels and then read the reset pixels in a manner in which the time between resetting and reading, and therefore pixel exposure, is greater for pixels adjacent edges of the sensor than for pixels adjacent a center of the sensor.

29. The camera of claim 28, wherein the solid-state image sensor comprises a complimentary metal oxide semiconductor (CMOS) sensor.

30. The camera of claim 28, wherein the counter-vignetting algorithm is configured to read pixels in a manner in which pixel exposure time increases as a function of distance from the center of the sensor.
